(19) United States
(12) Patent Application Publication
(10) Pub. No.: US 2020/0164443 A1
(43) Pub. Date: May 28, 2020

(54) TURNING DEVICE, USE OF A HYDROSTATIC BEARING AND METHOD FOR TURNING A WORKPIECE

(71) Applicant: J.G. WEISSER SÖHNE GMBH & CO. KG, St. Georgen (DE)

(72) Inventors: Reiner JÖRG, Schramberg (DE); Thorsten RETTICH, Konigsfeld (DE); Thomas MÜLLER, St. Georgen (DE); Janik DORER, Guttenbach (DE)

(73) Assignee: J.G. Weisser Söhne GmbH & Co. KG, St. Georgen (DE)

(21) Appl. No.: 16/611,666

(22) PCT Filed: May 23, 2018
(86) PCT No.: PCT/EP2018/063566

§ 371 Date: Nov. 7, 2019

(30) Foreign Application Priority Data
May 23, 2017 (DE) 10 2017 111 267.7

(51) Int. Cl. B23B 3/16; B23Q 1/38

(52) U.S. Cl. CPC B23B 3/161; B23Q 1/38

(57) ABSTRACT

For a turning machine (1) that can be used for rotary turning, the tool holder (20) is hydrostatically mounted. A method corresponding to this is described, and it is provided to use a hydrostatic bearing (8, 9) for the damping of mechanical vibrations of a tool holder (20) and/or for the permanent mounting of a tool holder (20) of a turning machine (1).

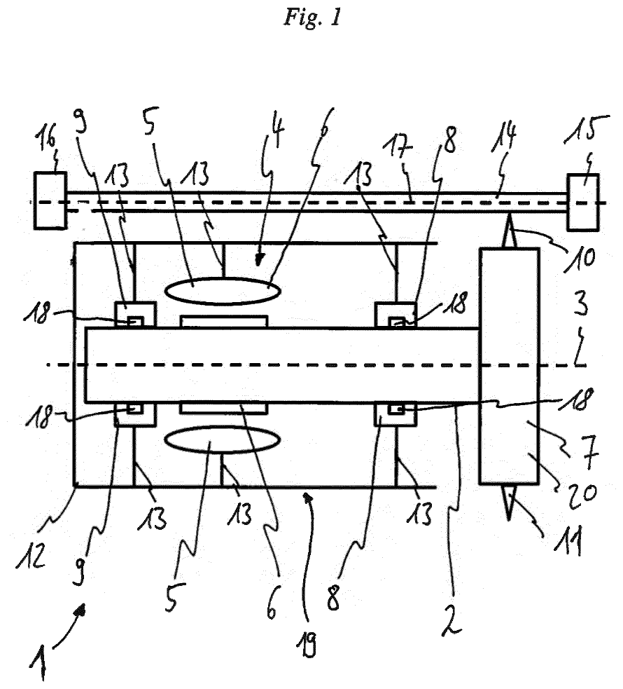

### BACKGROUND

The invention relates to a turning machine, by which a workpiece can be machined, and to a method for the turning machining of a workpiece. It is known for a turning machine to be used to perform, for example, a workpiece machining process referred to as rotary turning.

It has proven advantageous if, during the turning machining, during which the workpiece rotates, the tool holder of the turning machine is rotated simultaneously. In this way, it is made possible to reduce the machining time and produce torsion-free surfaces.

It has however been found that, as a result of these simultaneously performed rotational movements, increased precision requirements are placed on the turning machine.

Against this background, it is an object of the invention to create a turning machine which permits rotary turning with improved precision.

### SUMMARY

To achieve the object, one or more features according to the invention are provided. In particular, to achieve the stated problem in the case of a turning machine of the type mentioned in the introduction, it is thus provided according to the invention that the turning machine has a motor, which drives a shaft about an axis of rotation, and a tool holder, which is rotationally connected to the shaft and which is rotatable about the axis of rotation, and that the tool holder is hydrostatically mounted by a hydrostatic bearing. It is particularly advantageous if the hydrostatic bearing acts as a damping member.

The particular advantage of the use of a hydrostatic bearing arrangement consists in that, in this way, it can be achieved that mechanical vibrations are dampened. In this way, rotary turning with improved precision is made possible.

In one embodiment of the turning machine according to the invention, provision may be made whereby the tool holder is formed as a tool revolver, at least two tools being exchangeable by rotation of the tool revolver about the axis of rotation. In this way, it can be achieved that the usage possibilities of the turning machine are increased. By use of the hydrostatic bearing arrangement, the machining accuracy is not impaired as a result of a tool exchange.

In a further embodiment of the turning machine according to the invention, provision may be made whereby the hydrostatic bearing is arranged and/or configured such that mechanical vibrations of the tool holder that are generated by the workpiece during turning machining and/or by the motor are dampened. This is advantageous because mechanical vibrations are generated in particular by the workpiece during the turning machining thereof and by the motor that drives the tool holder. Damping of specifically these vibrations is therefore advantageous. Accordingly, the hydrostatic bearing may for example be arranged between the motor and the tool holder and/or be configured as a permanent bearing and/or as a bearing that imparts a damping action in one or more linearly independent spatial directions.

In order to dampen mechanical vibrations in an effective manner, provision may be made, in a further embodiment of the turning machine according to the invention, whereby the hydrostatic bearing is arranged on a mechanical connection path between the motor and the tool holder. For this purpose, provision may for example advantageously be made whereby the hydrostatic bearing is arranged on a mechanical connection path between a stator of the motor and the tool holder. Alternatively or in addition, provision may be made whereby the hydrostatic bearing is arranged on a mechanical connection path between a rotor of the motor and the tool holder. It may be particularly advantageous if the mechanical connection path forms a main transmission path of mechanical vibrations that are generated by the motor, in particular by the stator, and transmitted to the tool holder. The main transmission path may for example be characterized by the fact that it forms a transmission path via which a maximum amount of vibration energy is transmitted, in particular by means of the stator of the motor, to the tool holder. This would apply in any case if no hydrostatic bearing were arranged on the main transmission path and thus the mechanical vibrations were not dampened.

In a further embodiment of the turning machine according to the invention, provision may be made whereby the hydrostatic bearing is arranged on the shaft. In this way, firstly, the shaft is mounted and, secondly, in this way, mechanical vibrations that are transmitted to the shaft or present at the shaft are hydrostatically dampened. In this way, the tool holder can also be indirectly dampened, because it is rotationally connected to the shaft. It may be particularly advantageous if the hydrostatic bearing is arranged on the shaft between the motor and the tool holder, in particular between a rotor and/or stator of the motor and the tool holder. Alternatively, provision may also be made whereby the hydrostatic bearing is arranged on the shaft on the opposite side of the tool holder as viewed from the motor. It is preferable for in each case one hydrostatic bearing to be arranged at both of the positions just described, that is to say in front of and behind the tool holder. In this way, the shaft can be completely and easily hydrostatically mounted in a mechanically stable manner.

To ensure particularly reliable damping, provision may be made, in a further embodiment of the turning machine according to the invention, whereby the hydrostatic bearing is a bearing that imparts permanent hydrostatic mounting. A similar advantage may be achieved in the case of an embodiment in which provision may alternatively or additionally be made whereby the tool holder is permanently hydrostatically mounted. The permanent mounting is preferably realized during machining of the workpiece and/or during an exchange of a tool, for example of the tool already mentioned above.

In a further embodiment of the turning machine according to the invention, provision may be made whereby the hydrostatic bearing imparts hydrostatic mounting of the tool holder along at least two, preferably three, linearly independent spatial directions. It may be particularly advantageous if hydrostatic mounting is imparted radially and/or axially in relation to the axis of rotation. It can also be stated that the hydrostatic mounting imparts damping along the stated spatial directions. Damping along the stated radial direction has the advantage that particularly precise workpiece machining is made possible along said radial direction. Precision along said radial direction is of particular importance because very high precision is required in this direction and also because the forces transmitted between the workpiece and the tool holder are particularly high. Adequate damping in an axial direction can be of crucial importance in particular during rotary turning because, here, the tool often engages obliquely on the workpiece. Particularly high precision is however obtained if damping is realized by the hydrostatic mounting along all three spatial directions.

In a further embodiment of the turning machine according to the invention, provision may be made whereby, on the tool holder, a tool is implemented which is shaped such that the workpiece can be machined during a rotational movement of the tool holder. It is preferable here for the tool to be movable relative to the tool holder. In a further embodiment of the turning machine according to the invention, provision may alternatively or additionally be made whereby the motor is designed to effect a tool feed of the tool holder during turning machining of the workpiece. Such embodiments of the invention have the advantage that, in this way, particularly effective and as far as possible torsion-free rotary turning can be made possible.

To permit the most precise possible machining, provision may be made, in a further embodiment of the turning machine according to the invention, whereby the shaft and/or the axis of rotation about which the shaft is rotatable is oriented parallel to a rotational axis of a workpiece spindle of the turning machine.

To achieve the stated object, the use of a hydrostatic bearing in a first form and in a second form related to the first form is also provided. The two related forms of use may also be combined with one another.

In particular, to achieve the stated object, it is thus firstly provided to use a hydrostatic bearing for damping mechanical vibrations of a tool holder of a turning machine, wherein the turning machine has a motor which drives a shaft about an axis of rotation, and wherein the tool holder is rotationally connected to the shaft and is rotatable about the axis of rotation. Preferably, the mechanical vibrations are generated by a workpiece during the turning machining thereof and/or by the motor of the turning machine and transmitted to the tool holder. Due to the damping thus imparted, rotary turning with improved precision is made possible. The turning machine is preferably designed according to the invention, in particular as described above and/or as claimed in any of the patent claims directed to a turning machine.

In particular, to achieve the stated object, it is thus secondly provided to use a hydrostatic bearing for the permanent mounting of a tool holder of a turning machine. The turning machine is preferably designed according to the invention, in particular as described above and/or as claimed in any of the patent claims directed to a turning machine. By the permanent mounting, damping of the tool holder is imparted, such that rotary turning with improved precision is made possible.

To achieve the stated object, the features directed to a method are furthermore provided according to the invention. In particular, to achieve the stated object, it is thus provided according to the invention, in the case of a method of the form described in the introduction, that the workpiece is machined while a tool holder of a turning machine is rotated, and that the tool holder is hydrostatically mounted. The turning machine is preferably designed according to the invention, in particular as described above and/or as claimed in any of the patent claims directed to a turning machine. By virtue of the tool holder being hydrostatically mounted during the rotary turning, mechanical vibrations can be dampened, such that greater machining precision is attained.

To improve the machining precision, in one embodiment of the method according to the invention, provision may be made whereby the tool holder is hydrostatically mounted permanently. In particular, provision may be made whereby the tool holder is hydrostatically mounted during the turning machining of the workpiece and/or during an exchange of a tool. In particular in the latter case, the tool holder is preferably formed as a tool revolver.

To further improve the machining precision, in a further embodiment of the method according to the invention, provision may be made whereby the tool holder is hydrostatically mounted such that mechanical vibrations of the tool holder that are generated by the workpiece during turning machining and/or by the motor are dampened.

To improve the machining precision, in a further embodiment of the method according to the invention, provision may be made whereby mechanical vibrations are generated by the motor and are transmitted to the tool holder, whereby a main transmission path of the generated mechanical vibrations is distinguished, and whereby the mechanical vibrations are dampened on the main transmission path owing to the hydrostatic mounting.

### BRIEF DESCRIPTION OF THE DRAWINGS

The invention will now be described in more detail on the basis of one or a few exemplary embodiments, but is not restricted to these few exemplary embodiments. Further exemplary embodiments will emerge from combination of the features of individual or multiple patent claims with one another and/or with individual or further features of the exemplary embodiments.

In the FIGURE:

The sole FIGURE shows an exemplary embodiment of a turning machine 1 according to the invention.

### DETAILED DESCRIPTION

The turning machine 1 illustrated in the FIGURE may be used in particular for rotary turning with high machining accuracy.

For this purpose, the turning machine 1 has a workpiece 14 which is clamped into a tailstock 16 and which can be set in rotational motion by the tool spindle 15. In an alternative exemplary embodiment, the workpiece 14 is not additionally clamped into a tailstock 16. In the exemplary embodiment shown in the FIGURE, the workpiece rotates, for the machining thereof, about the rotational axis 17 of the tool spindle 15. Furthermore, a device (not illustrated in any more detail) is designed for the three-dimensional translational movement of the workpiece 14.

In alternative exemplary embodiments, the workpiece 14 may be clamped, and/or capable of being set in linear and/or rotational motion, in some other way, wherein embodiments may also be provided in which a translational movement of the workpiece 14 can be effected only along fewer than three spatial directions, or else cannot be effected at all. A translational movement may for example also be effected by mobility of a tool 10, 11 relative to the tool holder 20.

In the exemplary embodiment shown in the FIGURE, a shaft 2 can be set in rotational motion about the axis of rotation 3 by a motor 4, which has a stator 5 and a rotor 6. Here, the axis of rotation 3 and thus also the shaft 2 are oriented parallel to the rotational axis 17. Here, the motor 4 is designed to effect a tool feed of the tool revolver 7 during turning machining of the workpiece 14.

In further exemplary embodiments, the axis of rotation 3, which constitutes a pivot axis, may also be oriented perpendicularly or in some other way relative to the rotational axis 17 of the workpiece 14.

A tool holder 20 in the form of a tool revolver 7 is rotationally connected to the shaft 2 in the FIGURE such that the tool revolver 7 can be set in rotational motion about the axis of rotation 3 by the motor 4. The tool revolver 7 has a multiplicity of tools 10, 11, of which only two tools 10, 11 are explicitly illustrated in the FIGURE. In the situation shown in the FIGURE, the tool 10 is presently provided for machining the workpiece 14. The workpiece 14 can be machined owing to the rotation of the workpiece 14 and the contact with the tool 10, 11.

The FIGURE shows, by way of example, two tools 10, 11, which are configured for machining a radially oriented workpiece surface. Instead of or in addition to these tools 10, 11, use may also be made of tools which permit machining of an axially oriented workpiece surface.

Rotary turning is achieved by virtue of the workpiece 14 being rotated and machined while the tool revolver 7 is rotated. Furthermore, during the machining, the workpiece 14 and the tool 10 are moved relative to one another along the axis of rotation 3 and thus also along the rotational axis 17. Thus, the relative movement of the tool 10 with respect to a fixed point of the workpiece 14 describes a three-dimensional curve. It can also be stated that the tool 10 performs a pivoting movement during the workpiece machining. Correspondingly, the cutting edge of the tool 10 can be shaped so as to describe a segment of the three-dimensional curve.

The tool 10, 11 can be exchanged by virtue of the tool revolver 7 being correspondingly rotated onward.

The shaft 2 and thus the tool revolver 7 are permanently hydrostatically mounted by means of the hydrostatic bearings 8, 9. Here, the hydrostatic bearings 8, 9 are arranged and configured such that the pivoting movement of the tool 10, 11 that is performed during the workpiece machining is hydrostatically mounted, such that mechanical vibrations are dampened. The hydrostatic bearings 8, 9 thus act in each case as a damping member 19. Thus, firstly, mechanical vibrations of the tool revolver 7 that are generated by the motor 4 are dampened, and secondly, mechanical vibrations of the tool revolver 7 that are generated by the workpiece 14 during the turning machining are also dampened.

The hydrostatic bearings 8, 9 are each of annular form. They each fully surround the shaft 2.

Here, the hydrostatic bearing 8 is arranged spatially between the motor 4 and the tool revolver 7. The further hydrostatic bearing 9 is arranged on the shaft 2 on the opposite side of the tool revolver 7 as viewed from the motor 4. The shaft 2 and the tool revolver 7 are mounted exclusively by the two hydrostatic bearings 8, 9. In alternative exemplary embodiments, mounting may also be realized partially by non-hydrostatic means, for example by virtue of only the bearing 8 being designed as a hydrostatic bearing 8.

In the exemplary embodiment shown in the FIGURE, the stator 5 of the motor 4 and the hydrostatic bearings 8, 9 are in each case mechanically connected by a mechanical connection 13 to the housing 12 of the turning machine 1. In the exemplary embodiment shown in the FIGURE, the hydrostatic bearings 8, 9 are in each case arranged on a mechanical connection path between the motor 4 and the tool revolver 7. Here, said mechanical connection path forms a main transmission path of mechanical vibrations that are generated by the motor 4 and transmitted via the stator 6 of the motor 4 to the tool revolver 7.

The shaft 2 has two annular attachments 18 which are enclosed by the hydrostatic bearings 8, 9. In this way, hydrostatic mounting, and thus vibration damping, are imparted along two special directions that are oriented perpendicular to one another. Hydrostatic mounting and thus damping are thus realized radially and axially in relation to the axis of rotation 17.

It is provided, in the case of a turning machine 1 that can be used for rotary turning, for the tool holder 20 to be hydrostatically mounted. A method corresponding to this is described, and it is provided to use a hydrostatic bearing 8, 9 for the damping of mechanical vibrations of a tool holder 20 and/or for the permanent mounting of a tool holder 20 of a turning machine 1.

### LIST OF REFERENCE DESIGNATIONS

1 Turning machine
2 Shaft
3 Axis of rotation
4 Motor
5 Stator
6 Rotor
7 Tool revolver
8 Hydrostatic bearing
9 Further hydrostatic bearing
10 Tool
11 Further tool
12 Housing
13 Mechanical connection
14 Workpiece
15 Workpiece spindle
16 Tailstock
17 Rotational axis of 15
18 Attachment
19 Damping member
20 Tool holder

1. A turning machine (1) for machining a workpiece (14), the turning machine comprising:
a motor (4), which drives a shaft (2) about an axis of rotation (3);
a tool holder (7, 20), which is rotationally connected to the shaft (2) and which is rotatable about the axis of rotation (3); and
a hydrostatic bearing (8, 9) by which the tool holder (7, 20) is hydrostatically mounted by means.

2. The turning machine (1) as claimed in claim 1, wherein the tool holder (7, 20) comprises as a tool revolver (7, 20) that includes at least two tools (10, 11) that are adapted to be exchangeable by rotation of the tool revolver (7, 20) about the axis of rotation (3).

3. The turning machine (1) as claimed in claim 1, wherein the hydrostatic bearing (8, 9) is at least one of arranged or configured such that mechanical vibrations of the tool holder (7, 20) that are generated by at least one of the workpiece (14) during turning machining or the motor (4) are dampened.

4. The turning machine (1) as claimed in claim 1, wherein the hydrostatic bearing (8, 9) is arranged on a mechanical connection path between the motor (4) and the tool holder (7, 20), the mechanical connection path forming a main transmission path of mechanical vibrations that are generated by the motor and transmitted to the tool holder (7, 20).

5. The turning machine (1) as claimed in claim 1, wherein the hydrostatic bearing (8, 9) is arranged on the shaft (2).

6. The turning machine (1) as claimed in claim 1, wherein the hydrostatic bearing (8, 9) comprises a bearing (8, 9) that imparts permanent hydrostatic mounting.

7. The turning machine (1) as claimed in claim 1, wherein the hydrostatic bearing (8, 9) imparts hydrostatic mounting of the tool holder (7, 20) along at least two linearly independent spatial directions, said hydrostatic mounting being imparted at least one of radially or axially in relation to the axis of rotation (3).

8. The turning machine (1) as claimed in claim 1, further comprising a tool (10, 11) on the tool holder, the tool is shaped such that the workpiece (14) can be machined during a rotational movement of the tool holder (7, 20), and the tool (10, 11) being movable relative to the tool holder (7, 20).

9. The turning machine (1) as claimed in claim 1, wherein at least one of the shaft (2) or the axis of rotation (3) is oriented parallel to an axis of rotation (17) of a workpiece spindle (15) of the turning machine (1).

10. A method of damping mechanical vibrations of a tool holder (7, 20) of a turning machine (1), the method comprising:
providing a hydrostatic bearing (8, 9) by which the tool holder is hydrostatically mounted; and
damping the mechanical vibrations being generated by at least one of a workpiece (14) during turning machining thereof or a motor (4) of the turning machine (1) that are being transmitted to the tool holder (7, 20).

11. The method of claim 10, further comprising permanently mounting the tool holder (7, 20) using the hydrostatic bearing (8, 9).

12. A method for turning machining of a workpiece (14) on a turning machine, the method comprising:
hydrostatically mounting the tool holder (7, 20); and
machining the workpiece (14) while the tool holder (7, 20) of the turning machine (1) is rotated.

13. The method as claimed in claim 12, wherein the tool holder (7, 20) is hydrostatically mounted permanently, during the turning machining of the workpiece (14) and during an exchange of a tool (10, 11).

14. The method as claimed in claim 12, wherein the tool holder (7, 20) is hydrostatically mounted such that mechanical vibrations of the tool holder (7, 20) that are generated at least one of by the workpiece (14) during turning machining or by the motor (4) are dampened.

15. The method as claimed in claim 12, further comprising damping mechanical vibrations generated by the motor (4) that are transmitted to the tool holder (7, 20), wherein a main transmission path of the generated mechanical vibrations is distinguished, and the mechanical vibrations are dampened on the main transmission path by the hydrostatic mounting.

16. The turning machine (1) as claimed in claim 5, wherein the hydrostatic bearing (8, 9) is arranged spatially between the motor (4) and the tool holder (7, 20).

17. The turning machine (1) as claimed in claim 1, wherein the tool holder (7, 20) is permanently hydrostatically mounted during at least one of machining of the workpiece (14) or an exchange of a tool (10, 11).

18. The turning machine (1) as claimed in claim 1, wherein the motor (4) is configured to effect a tool feed of the tool holder (7, 20) during turning machining of the workpiece (14).

19. The turning machine (1) as claimed in claim 1, wherein the hydrostatic bearing (8, 9) acts as a damping member (19).
